(19) United States
(12) Patent Application Publication
(10) Pub. No.: US 2002/0088319 A1
(43) Pub. Date: Jul. 11, 2002

(54) Punch press and machining method of the punch press

(75) Inventor: Michiharu Ichikawa, Aichi (JP)

Correspondence Address: PEARNE & GORDON LLP, 526 SUPERIOR AVENUE EAST, SUITE 1200, CLEVELAND, OH, 44114-1484, US

(73) Assignee: Nissinbo Industries, Inc.

(21) Appl. No.: 10/028,196

(22) Filed: Dec. 20, 2001

(30) Foreign Application Priority Data
Dec. 27, 2000 (JP) P. 2000-398636

(51) Int. Cl. B26F 1/04; B26F 1/14

(52) U.S. Cl. 83/13; 83/552; 83/553; 483/1; 483/28

(57) ABSTRACT

A punch press for machining a plate-shaped workpiece by cooperation of an upper metal mold mounted on an upper turret and a lower metal mold mounted on a lower turret. The upper turret and the lower turret are rotationally driven. A plurality of lower metal molds are provided corresponding to a selected one of the upper metal molds, and the workpiece is machined after selection of one lower metal mold from among the plurality of lower metal molds.

### BACKGROUND OF THE INVENTION

1. Field of the Invention

The present invention relates to a punch press, and more particularly to a metal mold selection and machining method.

2. Description of the Related Art

A punchpress, for example, a turret punchpress comprises upper and lower turrets on the upper and lower sides, respectively. Each turret is mounted with several dozen kinds of metal molds. An upper metal mold and a lower metal mold as one set at the same position of the upper and lower turrets, in which the punching or deforming (concave and convex) machining is efficiently made in cooperation of the upper metal mold and the lower metal mold while passing a workpiece between the upper and lower turrets. The turret punch press employs the upper metal mold and the lower metal mold as one set, and rotates the upper and lower turrets at the same time to select desired upper and lower metal molds and perform machining.

FIG. 5 is a view showing a turret driving device for the conventional turret punch press. An upper turret 2 is attached to a shaft 6 supported by a rotational bearing portion 4 secured to a frame 1. A lower turret 3 is attached to a shaft 7 supported by a rotational bearing portion 5 secured to the frame 1. Chain wheels 8 and 9 are provided at the ends of the shafts 6 and 7, respectively, and chains 14, 15 are looped to pass around the chain wheels 8, 9 and the chain wheels 12, 13 secured to a drive shaft 11, respectively. The shaft 11 is rotated via a gear by a motor M0.

Conventionally, owing to such a driving structure employed, the upper and lower turrets can be driven by one motor, so that the upper metal mold and the lower metal mold are positioned at the same time to make machining such as punching. By employing such structure, the number of parts is reduced and the control is simplified.

FIG. 5 also shows the relation between upper and lower metal molds as conventionally employed.

An upper metal mold 21 is mounted into an upper turret 2 by being inserted from upward. A ram (not shown) is disposed directly above the machining position to hit the top portion of the upper metal mold 21 from above in machining. The hit upper metal mold 21 is moved downward, and in cooperation with the lower metal mold 22, works the workpiece W placed between both metal molds.

Since the upper turret 2 and the lower turret 3 are opposed and the workpiece W is passed between them, the lower metal mold 22 is pulled out of the turret to exchange the lower metal mold 22 (die) . This exchange procedure is performed as follows. First, the lower metal mold to be exchanged is moved rotationally to an exchanging station. After completion of the rotational movement, a screw for tightening a clamper 23 is loosened to draw out a die holder 22b to the right side in the figure. After exchanging a die of the lower metal mold 22, the die holder 22b is positioned by a positioning pin 24, while being inserted centrally into the turret on a holder base 22a, and lastly is fixed by the clamper 23.

Because this exchange is made in a narrow space between the upper and lower turrets 2 and 3, there is a problem that it consumes much time to make the exchange operation, and the operation is also complicated.

Also, it is required to change the metal mold used with the machining, particularly, the clearance of the lower metal mold corresponding to the upper metal mold, even for the same punching size, depending on the plate thickness or material of the workpiece. For example, in a case of employing a convex upper metal mold of φ10 mm and a concave lower metal mold of φ10.3 mm, the clearance is as large as 0.15 mm.

In machining, when the upper metal mold is of the same size, but the lower metal mold having a different clearance is only exchanged, there is a problem that management of the metal mold life is more complicated because the upper metal mold and the lower metal mold are consumed and worn differently.

The upper metal mold and the lower metal mold are managed and exchanged as a set owing to the relation between the method for driving the turrets and the clearance of the lower metal mold and the management of the metal mold life.

However, since the metal mold has to be exchanged depending on the kind (thickness or material) of workpiece, there is a problem that the exchange for setup might be increased to take a greater exchange time for setup, or expense more metal molds.

### SUMMARY OF THE INVENTION

The present invention has been achieved to solve the above-mentioned problems, and it is an object of the invention to provide a punch press for allowing only a lower metal mold to be selected, in which the conventional methods for driving the turrets and managing the metal molds are improved, and which there is no need of making the exchange for setup, even if the kind (thickness or material) of workpiece is changed.

According to the invention, there is provided a punch press for machining a plate-shaped workpiece in cooperation of an upper metal mold mounted on an upper turret and a lower metal mold mounted on a lower turret, in which each of the upper turret and the lower turret can be driven in rotation, and a plurality of lower metal molds are provided corresponding to one upper metal mold, one of the plurality of lower metal molds being selected depending on the workpiece

### BRIEF DESCRIPTION OF THE DRAWINGS

FIG. 1 is a front view showing a drive portion of the upper and lower turrets.

FIGS. 2A to 2C show metal mold positions in an upper turret (left side) and a lower turret (right side), wherein FIG. 2A is a view showing the metal mold positions of turret at the original position, FIG. 2B is a view showing the metal mold positions on the turret when machining the workpiece having a plate thickness of 1.6 mm, and FIG. 2C is a view showing the metal mold positions on the turret when machining the workpiece having a plate thickness of 6.0 mm.

FIG. 3 is an arrangement view of an upper metal mold and a lower metal mold in the invention.

FIG. 4 is a detailed cross-sectional view of the arrangement of the upper metal mold and the lower metal mold in the invention.

FIG. 5 is a side cross-sectional view showing a drive system in the conventional punch press.

FIG. 6 is a longitudinal cross-sectional view of the upper and lower metal molds.

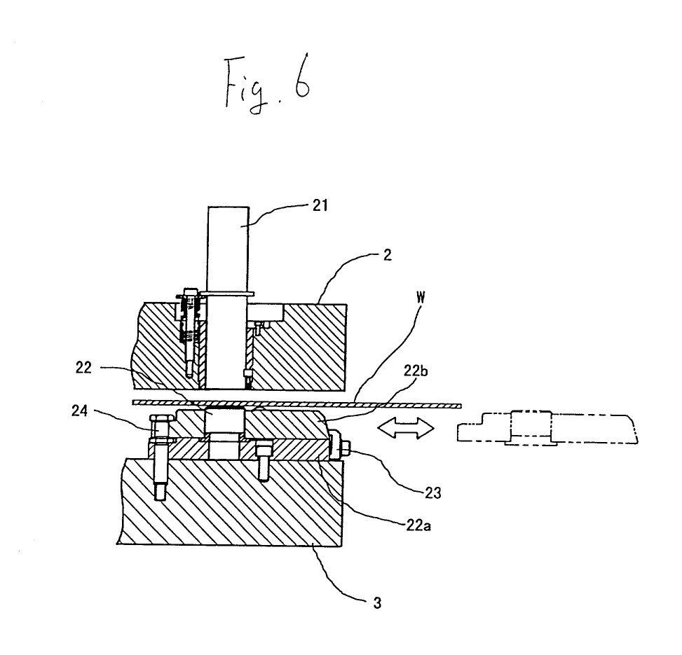

### DETAILED DESCRIPTION OF THE PRESENT INVENTION

The preferred embodiments of the present invention will be described below with reference to the accompanying drawings.

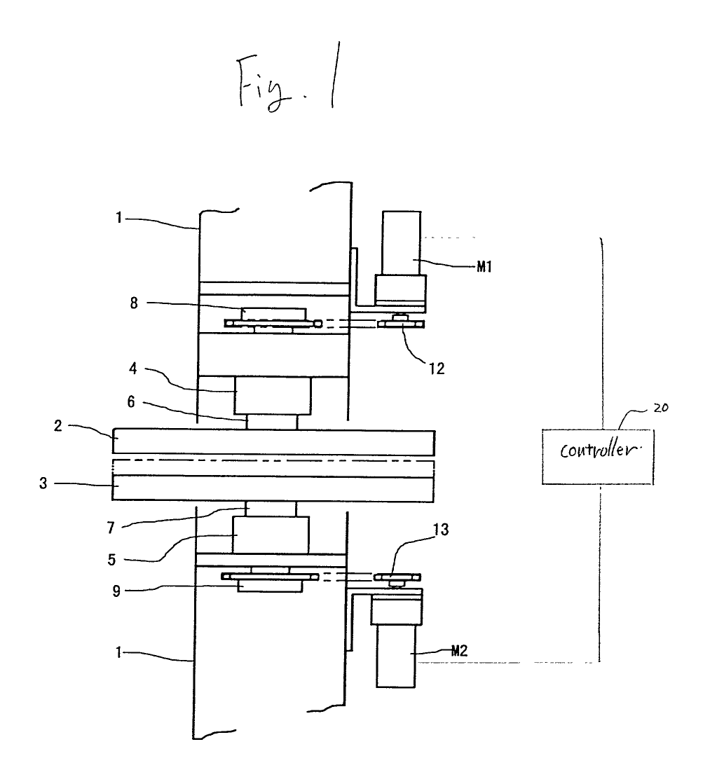

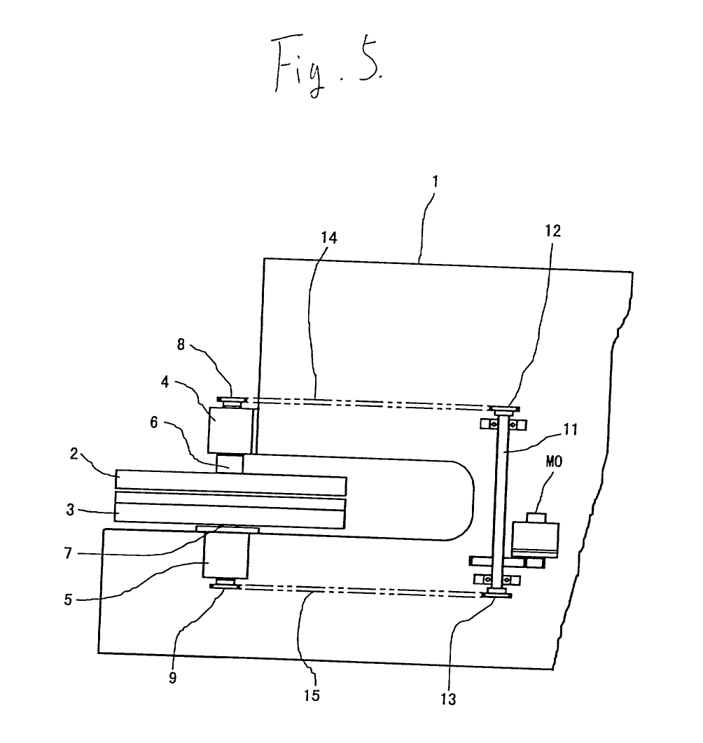

FIG. 1 is a view showing how to drive an upper turret 2 and a lower turret 3 in a punch press according to an embodiment of the invention. The upper turret is provided with a chain wheel 8 at an upper end portion of a shaft 6 supported by a rotation bearing portion 4 attached onto a frame 1. The chain looped between a chain wheel 12 attached to a shaft of a first motor M1 secured to the frame 1 and the chain wheel 8 transmits the rotation of the first motor M1 to the shaft 6. The lower turret 3 is likewise provided with a chain wheel 9 at a lower end portion of a shaft 7 supported by a rotation bearing portion 5 attached onto the frame 1. The chain looped between a chain wheel 13 attached to a shaft of a second motor M2 secured to the frame 1 and the chain wheel 9 transmits the rotation of the second motor M2 to the shaft 7. In this way, the upper turret 2 and the lower turret 3 can be rotated independently of each other. Instead of providing the first motor M1 and the second motor M2, a clutch may be provided in the shaft of FIG. 5 and turned on or off transmission of the rotation of motor M0 to the upper turret and the lower turret.

A controller 20 controls the motors M1 and M2 as an upper turret shaft and a lower turret shaft, respectively, for example. When the upper and lower turrets employ the metal molds at the same position, the controller 20 controls the rotation of the upper and lower turrets 2 and 3 at the same time, or when they employ the upper and lower metal molds at different positions, the controller 20 controls the rotation of the upper and lower turrets 2 and 3 in shortest rotational direction.

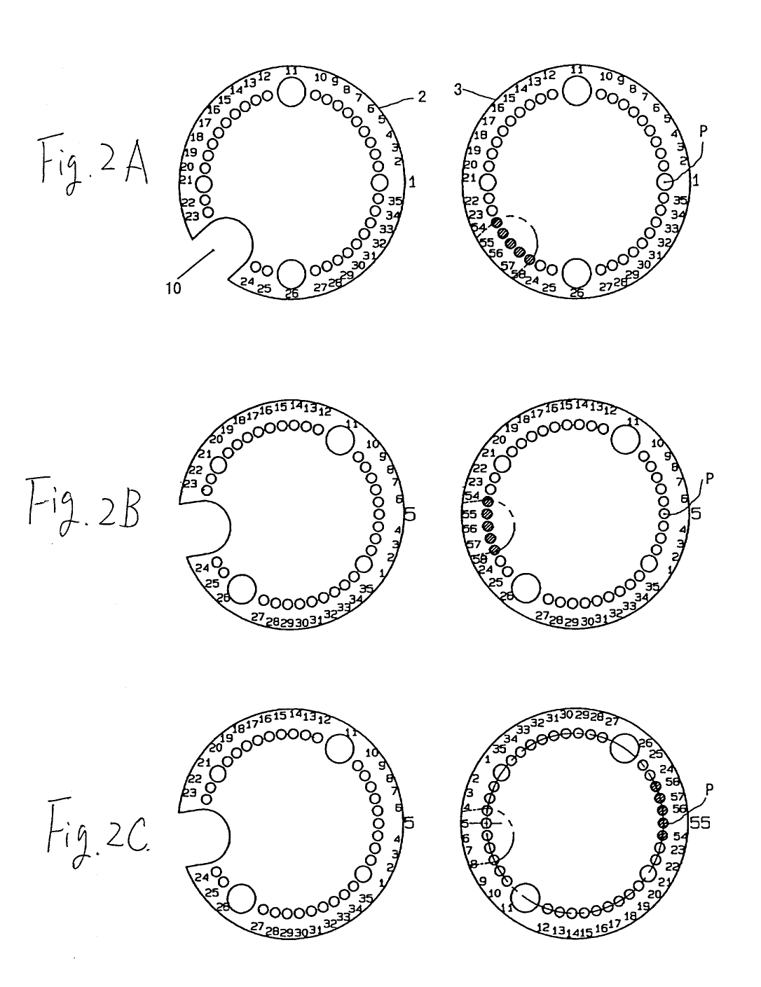

FIGS. 2A to 2C are views showing examples of the shape of the turrets 2, 3 and the arranged state of the metal molds. FIG. 2A is an arrangement view of the upper turret 2, in which the circular signs arranged in the circumferential direction denotes the metal molds, and the size of circular sign indicates the size of metal mold. Also, the number indicated along with the circular sign is a station number of the metal mold. The controller 20 stores the station number, and the kind and size of metal mold received at that station number. A notch 10 is provided in a part of the upper turret 2, and used in exchanging the lower metal mold.

Firstly, a method for exchanging the lower metal mold 22 will be set forth below. The lower turret 3 is rotationally positioned so that the lower metal mold 22 may be brought to a tool exchange position, while at the same time the upper turret 2 is rotationally positioned so that the notch 10 of the upper turret 2 may be positioned above the lower metal mold 22 to be exchanged. If the upper and lower turrets 2, 3 have been positioned, the lower metal mold 22 is removed upward through the notch 10 of the upper turret 2. A required lower metal mold is mounted at the removed place. The lower metal mold 22, like the upper metal mold 21, can be inserted into the lower turret 3, whereby there is no need for providing the conventional holder base 22a and clamper 23.

Then, the upper turret 2 is rotationally positioned to exchange the upper metal mold. Note that the order of exchanging the upper and lower metal molds may be arbitrary. Also, the lower metal mold or upper metal mold may be only exchanged.

An example of exchanging the lower metal mold only in the punching process will be set forth below.

Supposing that in FIG. 2A, a metal mold with station number 1 set at the machining position P is positioned at the original position, an instance where a hole of φ10 mm is punched in a general structure rolled plate (hereinafter referred to as an SS plate) having a plate thickness of 1.6 mm will be described with reference to FIG. 2B. The station number 5 for receiving the upper metal mold of φ10 mm is selected, and then rotationally positioned at the machining position P. Also, the lower metal mold with station number 5 that has a bore diameter of φ10.3 mm is selected. In a case where a hole of φ10 mm is punched in the SS plate having a plate thickness of 1.6 mm, the lower metal mold having a bore diameter of φ10.3 mm is employed with a clearance C of 0.15 mm. Then, when a hole of φ10 mm is punched in the SS plate having a plate thickness of 6.0 mm in the same manner as above, the lower metal mold is selected to have a bore diameter of φ11.2 mm. Since the same upper metal mold can be used, it is unnecessary to rotate the upper turret 2. However, the lower turret 3 is only rotationally positioned because the lower metal mold is different. When the lower metal mold of φ11.2 mm is accommodated at the station number 55, the lower turret 3 is only rotated as shown in FIG. 2C, so that the lower metal mold with station number 55 is positioned at the machining position P for punching.

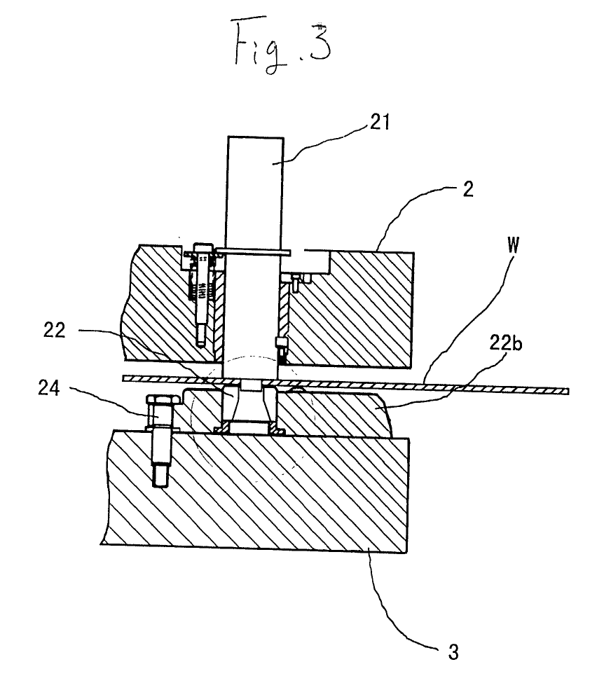

An arrangement of the upper turret 21 and the lower turret 22 of the invention is shown in FIG. 3.

FIG. 3 shows a punching process in cooperation of the upper metal mold and the lower metal mold in the punch press according to the invention.

The upper metal mold 21 mounted in the upper turret 2 is hit downward by a ram, not shown, so that a lower face of the upper metal mold 21 is brought in contact with an upper face of the workpiece W, to carry the workpiece W with an upper face of the lower metal mold 22 mounted in the lower turret 3. Further from that position, a blade 210 of the upper metal mold is protruded downward to enter a hole 220 of the lower metal mold, and punch the workpiece W by means of the blade 210 of the upper metal mold and the hole 220 of the lower metal mold. The ram is returned upward after the punching is completed, and at the same time the upper metal mold 21 is returned upward by a spring.

When the notch 10 for exchanging the lower metal mold is provided in the upper turret 2, the lower metal mold has an empty space corresponding to a space of the notch 10. Accordingly, when the notch 10 is provided, more lower metal molds 22 can be installed than the upper metal molds 21. When there is a machining repeated at high frequency, a few more kinds (clearances) of the lower metal molds may be provided so that the workpieces different in plate thickness or material can be worked with the upper metal molds 21.

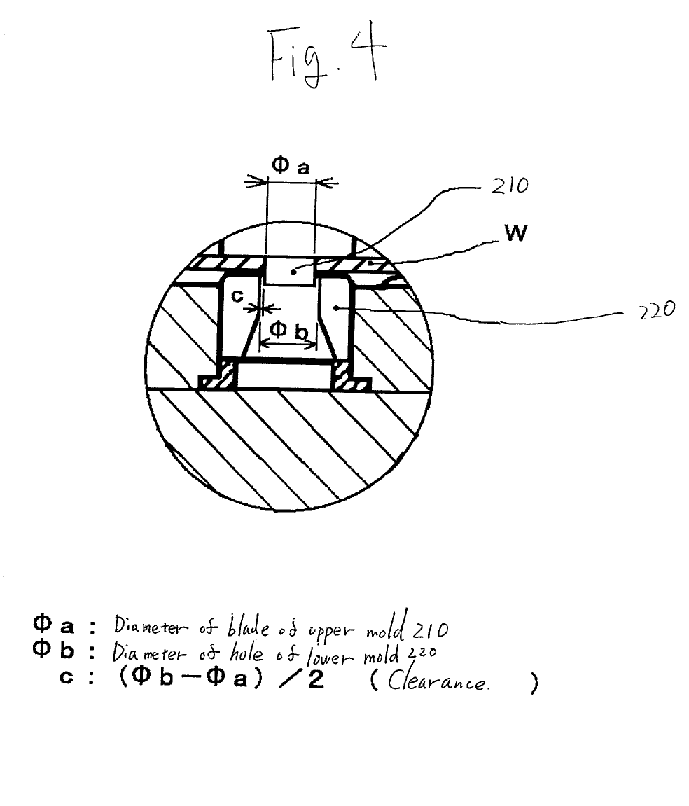

FIG. 4 is a view showing a clearance C between the blade 210 of the upper metal mold and the hole 220 of the lower metal mold. The clearance C is half of the difference between an outer size of the blade 210 of the upper metal mold and an inner size of the hole 220 of the lower metal mold (c=(φb−φa)/2). This clearance C is set such that, for example, in a case where the same hole having a diameter of φ10 mm is punched in the workpiece W, the blade 210 of the upper metal mold employs φ10 mm, but the hole 220 of the lower metal mold is varied depending on the kind (material or thickness) of the workpiece W, as mentioned above.

The upper metal mold and the lower metal mold may be consumed or worn in different degrees, because they are used in different number of times. Therefore, the life management for the metal molds is important, but the number of uses may be counted and saved for every station or metal mold to bring about an alarm for every upper metal mold and every lower metal mold.

The present invention provides a punch press for machining a plate-like workpiece by cooperation of the upper metal mold mounted on the upper turret and the lower metal mold mounted on the lower turret, in which the same upper metal mold and the lower metal mold having a different clearance can be selected for machining, depending on the thickness or material of the workpiece, when making the same punching or deforming machining, bringing about the following effects.

(a) The number of metal molds received in the turret is not greatly different from the conventional number, but the combination of the upper metal mold and the lower metal mold can be changed whereby more kinds of workpiece can be worked without exchanging the metal mold.

(b) The machining time is relatively increased because the number of exchanging the metal mold is reduced.

(c) Because of the notch provided on the upper turret, the time for exchanging the metal mold is shortened, and the effective machining time occupied in the operation time is increased.

What is claimed is:

1. A punch press comprising:
a plurality of upper metal molds;
a plurality of lower metal molds for machining a workpiece in cooperation with the upper metal molds, the lower metal molds corresponding to the upper metal molds;
an upper turret for accommodating the plurality of upper metal mold;
a lower turret for accommodating the plurality of lower metal molds;
a motor for rotationally driving each of the upper turret and the lower turret; and
a controller for controlling the motor,
wherein the controller selects one of the plurality of lower metal molds corresponding to a selected one of the plurality of upper metal molds in accordance with the kind of workpiece, to perform the machining.

2. The punch press according to claim 1, wherein the plurality of lower metal molds corresponding to a selected one of the plurality of upper metal molds have different clearances from each other.

3. The punch press according to claim 1, wherein the motor comprises a first motor for driving the upper turret and
a second motor for driving the lower turret.

4. The punch press according to claim 1, wherein the upper turret is provided with a notch used in exchanging one of the plurality of lower metal molds.

5. A machining method using a punch press, including:
selecting an upper metal mold for machining a workpiece;
selecting one of a plurality of lower metal molds having different clearances, the lower metal molds mounted on a turret, in accordance with the upper metal mold and the workpiece; and
machining the workpiece in cooperation of the upper metal mold and the selected one of the lower metal molds.
